(19) United States
(12) Patent Application Publication
(10) Pub. No.: US 2017/0159611 A1
(43) Pub. Date: Jun. 8, 2017

(54) LIQUID NATURAL GAS STORAGE TANK PRESSURE CONTROL SYSTEM

(71) Applicant: Transfuels LLC, Salt Lake City, UT (US)

(72) Inventors: Zack Porter, Salt Lake City, UT (US); Dana Walker, South Jordan, UT (US); Brandon Davenport, Kearns, UT (US); Buerebista Ursu, Centerville, UT (US)

(21) Appl. No.: 15/369,722

(22) Filed: Dec. 5, 2016

Related U.S. Application Data
(60) Provisional application No. 62/263,019, filed on Dec. 4, 2015.

(51) Int. Cl. F02M 21/02; F17C 13/02; F17C 7/04; F02M 21/06; F17C 1/00

(52) U.S. Cl. CPC F02M 21/0239; F02M 21/06; F02M 21/0221; F02M 21/0287; F17C 1/00; F17C 7/04; F17C 13/025; F17C 2221/033; F17C 2223/0161; F17C 2225/0123; F17C 2227/0341; F17C 2250/03; F17C 2250/0626; F17C 2260/021; F17C 2270/0168

(57) ABSTRACT

Disclosed herein is a pressure control system for a liquid natural gas (LNG) storage tank. The pressure control system comprises a second heat exchanger, comprising a first inlet fluidly coupled with the LNG storage tank and a first outlet fluidly coupled with the LNG storage tank. The pressure control system also comprises a coolant, fluidly coupled with a second inlet of the second heat exchanger. The heat exchanger is configured to transfer energy from the coolant to the LNG from the LNG storage tank to vaporize the LNG into compressed natural gas (CNG). The pressure control system also comprises a first control valve selectively operable to allow LNG to flow from the LNG storage tank to the heat exchanger and to allow CNG to flow from the heat exchanger to the LNG storage tank when a pressure within the LNG storage tank is below a lower pressure threshold.

### CROSS-REFERENCE TO RELATED APPLICATION

This application claims the benefit of U.S. Provisional Patent Application No. 62/263,019, filed Dec. 4, 2015, which is incorporated herein by reference.

### FIELD

The present disclosure relates generally to pressurized storage tanks, and more particularly to controlling the pressure within an LNG storage tank.

### BACKGROUND

Natural gas is considered a clean-burning fossil fuel that is used to reduce carbon-dioxide emissions. Liquid natural gas or liquefied natural gas (LNG) and compressed natural gas (CNG) are utilized as alternative fuel sources for vehicles. Generally, when used as a fuel source for vehicles, LNG and CNG can reduce harmful gas emissions versus conventional vehicle fuel sources.

Many vehicles with an engine powered by CNG include onboard tanks for storing CNG prior to introducing CNG to the engine. LNG requires less space to store the same amount of energy compared to CNG. Accordingly, some vehicles include onboard tanks for storing LNG, which is converted to CNG prior to being introduced to the engine. LNG stored in onboard tanks should be maintained at a desirable pressure to facilitate compatibility with CNG-powered engines (e.g., engines calibrated to be fueled by CNG).

### SUMMARY

The subject matter of the present application has been developed in response to the present state of the art, and in particular, in response to the problems and needs of storing LNG in conventional CNG vehicles that has not yet been fully solved by currently available systems. Storing natural gas as LNG, as opposed to CNG, allows for considerable space savings on a vehicle. However, one known problem for storing LNG in an onboard tank is controlling the pressure in the storage tank to ensure adequate delivery pressure to the engine of the vehicle. Typically, LNG must be heated to a gaseous state before entering many engines, which requires expensive and space-consuming heating methods and systems. In view of the foregoing, the subject matter of the present application has been developed to provide a pressure control system, apparatus, and method for an LNG vehicle storage tank, to maintain a desirable pressure in the storage tank for ensuring adequate delivery pressure to the engine, which overcomes many of the shortcomings of the prior art.

Disclosed herein is a pressure control system for a liquid natural gas (LNG) storage tank. The pressure control system comprises a second heat exchanger, comprising a first inlet fluidly coupled with the LNG storage tank and a first outlet fluidly coupled with the LNG storage tank. The pressure control system also comprises a coolant, fluidly coupled with a second inlet of the second heat exchanger. The heat exchanger is configured to transfer energy from the coolant to the LNG from the LNG storage tank to vaporize the LNG into compressed natural gas (CNG). The pressure control system also comprises a first control valve selectively operable to allow LNG to flow from the LNG storage tank to the heat exchanger and to allow CNG to flow from the heat exchanger to the LNG storage tank when a pressure within the LNG storage tank is below a lower pressure threshold. The preceding subject matter of this paragraph characterizes example 1 of the present disclosure.

The first control valve is further selectively operable to prevent LNG from flowing from the LNG storage tank to the second heat exchanger and to prevent CNG from flowing from the heat exchanger to the LNG storage tank when pressure within the LNG storage tank is above an upper pressure threshold that is higher than the lower pressure threshold. The preceding subject matter of this paragraph characterizes example 2 of the present disclosure, wherein example 2 also includes the subject matter according to example 1, above.

The upper pressure threshold and the lower pressure threshold are dynamically adjustable based on operating conditions of a vehicle comprising the pressure control system. The preceding subject matter of this paragraph characterizes example 3 of the present disclosure, wherein example 3 also includes the subject matter according to example 2, above.

The pressure control system further comprises a coolant pump selectively operable to pump the coolant into the second heat exchanger. The preceding subject matter of this paragraph characterizes example 4 of the present disclosure, wherein example 4 also includes the subject matter according to any one of examples 1-3, above.

The pressure control system further comprises a bypass valve selectively operable to allow coolant to be pumped into the second heat exchanger by the coolant pump. The second heat exchanger and the coolant pump form a closed coolant loop when the bypass valve allows coolant to be pumped into the second heat exchanger by the coolant pump. The preceding subject matter of this paragraph characterizes example 5 of the present disclosure, wherein example 5 also includes the subject matter according to example 4, above.

Also disclosed herein is a vehicle that comprises an engine fueled by liquid natural gas (LNG), a storage tank configured to store LNG, a fuel delivery system configured to deliver LNG from the storage tank to the engine, and a pressure control system. The pressure control system comprises a second heat exchanger, comprising a first inlet fluidly coupled with the LNG storage tank and a first outlet fluidly coupled with the LNG storage tank. The pressure control system also comprises a coolant, fluidly coupled with a second inlet of the second heat exchanger. The second heat exchanger is configured to transfer energy from the coolant to the LNG from the LNG storage tank to vaporize the LNG into compressed natural gas (CNG). The pressure control system further comprises a first control valve selectively operable to allow LNG to flow from the LNG storage tank to the second heat exchanger and to allow CNG to flow from the second heat exchanger to the LNG storage tank when a pressure within the LNG storage tank is below a lower pressure threshold. The preceding subject matter of this paragraph characterizes example 6 of the present disclosure.

The first control valve is further selectively operable to prevent LNG from flowing from the LNG storage tank to the second heat exchanger and to prevent CNG from flowing from the second heat exchanger to the LNG storage tank when pressure within the LNG storage tank is above an upper pressure threshold that is higher than the lower pressure threshold. The preceding subject matter of this paragraph characterizes example 7 of the present disclosure, wherein example 7 also includes the subject matter according to example 6, above.

The engine is operable in a keyed-on state and a running state. When the engine is operating in the keyed-on state, the upper pressure threshold is a first upper pressure threshold. When the engine is operating in the running state, the upper pressure threshold is a second upper pressure threshold. The first upper pressure threshold is different than the second upper pressure threshold. The preceding subject matter of this paragraph characterizes example 8 of the present disclosure, wherein example 8 also includes the subject matter according to example 7, above.

The first upper pressure threshold is higher than the second upper pressure threshold. The preceding subject matter of this paragraph characterizes example 9 of the present disclosure, wherein example 9 also includes the subject matter according to example 8, above.

The first upper pressure threshold is about 140 psig and the second upper pressure threshold is about 120 psig. The preceding subject matter of this paragraph characterizes example 10 of the present disclosure, wherein example 10 also includes the subject matter according to example 9, above.

The fuel delivery system comprises a first heat exchanger, separate from the second heat exchanger, fluidly coupled with the coolant and configured to transfer energy from the coolant to the LNG being delivered to the engine to vaporize the LNG into CNG before delivery to the engine. The preceding subject matter of this paragraph characterizes example 11 of the present disclosure, wherein 11 also includes the subject matter according to any one of examples 9 or 10, above.

The vehicle further comprises a coolant system configured to deliver coolant to the first heat exchanger and the engine. The coolant system comprises a main coolant pump operable to pump coolant through the first heat exchanger and the engine. The preceding subject matter of this paragraph characterizes example 12 of the present disclosure, wherein example 12 also includes the subject matter according to example 11, above.

The pressure control system further comprises a secondary coolant pump, separate from the main coolant pump, operable to pump coolant into the second heat exchanger. The preceding subject matter of this paragraph characterizes example 13 of the present disclosure, wherein example 13 also includes the subject matter according to example 12, above.

The engine is operable in a keyed-on state and a running state. In the keyed-on state, coolant is pumped into the second heat exchanger exclusively by the secondary coolant pump. In the running state, coolant is pumped into the second heat exchanger exclusively by the main coolant pump. The preceding subject matter of this paragraph characterizes example 14 of the present disclosure, wherein example 14 also includes the subject matter according to example 13, above.

The pressure control system further comprises a bypass valve that is closed in the running state and open in the keyed-on state. When open, coolant bypasses the first heat exchanger to prevent coolant from being delivered to the first heat exchanger and coolant is allowed to be pumped into the second heat exchanger by the secondary coolant pump. When closed, coolant bypasses the secondary coolant pump and coolant is allowed to be pumped into the second heat exchanger and the first heat exchanger by the main coolant pump. The preceding subject matter of this paragraph characterizes example 15 of the present disclosure, wherein example 15 also includes the subject matter according to example 14, above.

The second heat exchanger and the secondary coolant pump form a closed coolant loop when the bypass valve is open. The preceding subject matter of this paragraph characterizes example 16 of the present disclosure, wherein example 16 also includes the subject matter according to example 15, above.

The vehicle further comprises a shroud enclosure. The storage tank is enclosed within the shroud enclosure. The pressure control system is external to the shroud enclosure. The fuel delivery system is enclosed within the shroud enclosure. The preceding subject matter of this paragraph characterizes example 17 of the present disclosure, wherein example 17 also includes the subject matter according to any one of examples 1-16, above.

Additionally disclosed herein is a method of controlling pressure in a liquid natural gas (LNG) storage tank, configured to supply natural gas to an engine. The method comprises passing coolant from an engine coolant system of the engine through a second heat exchanger. The method also comprises passing LNG from the LNG storage tank through the second heat exchanger to heat the LNG into first vaporized LNG when a pressure within the LNG storage tank is below a lower pressure threshold. The method additionally comprises transmitting the first vaporized LNG to the LNG storage tank. The preceding subject matter of this paragraph characterizes example 18 of the present disclosure.

The method further comprises, when the engine is running and a pressure within the LNG storage tank is below a first upper pressure threshold, closing a coolant bypass valve, passing coolant from the engine coolant system of the engine through a first heat exchanger, separate from the second heat exchanger, passing LNG from the LNG storage tank through the first heat exchanger to heat the LNG into second vaporized LNG, and transmitting the second vaporized LNG to the engine. The preceding subject matter of this paragraph characterizes example 19 of the present disclosure, wherein example 19 also includes the subject matter according to example 18, above.

The method further comprises, when the engine is keyed-on and the pressure within the LNG storage tank is below a second upper pressure threshold, different than the first upper pressure threshold, opening a coolant bypass valve and passing coolant from the engine coolant system through a closed coolant loop comprising the coolant bypass valve and the second heat exchanger, wherein the closed coolant loop does not include the first heat exchanger. The preceding subject matter of this paragraph characterizes example 20 of the present disclosure, wherein example 20 also includes the subject matter according to example 19, above.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the disclosure may be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 is a schematic diagram of a pressure control system for an LNG storage tank, according to one or more embodiments of the present disclosure;

FIG. 2 is a schematic diagram of a pressure control system for an LNG storage tank, according to one or more embodiments of the present disclosure;

FIG. 3 is a schematic block diagram of a vehicle with an engine powered by LNG stored in an LNG storage tank, according to one or more embodiments of the present disclosure and

FIG. 4 is a schematic flow chart of a method of controlling pressure in an LNG storage tank, according to one or more embodiments of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

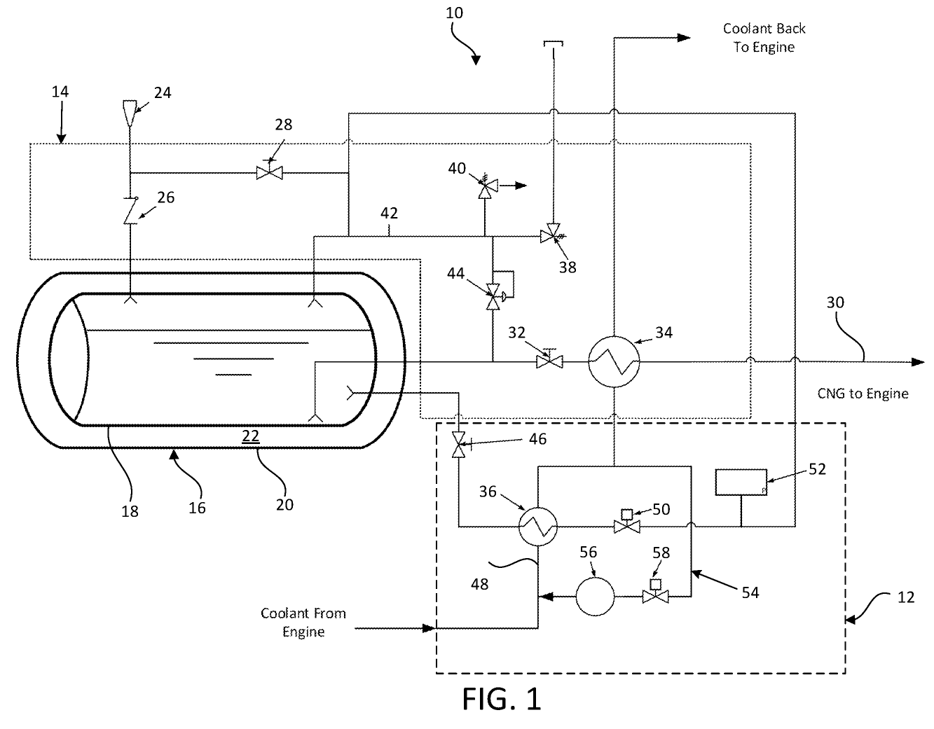

Referring to FIG. 1, according to one embodiment, a pressure control system 12, for a storage tank 16 that stores liquid natural gas (LNG), is shown as part of an overall fuel delivery system 10. The storage tank 16 is a dual-walled tank that includes an inner tank 18, or storage vessel, surrounded by an outer tank 20, or shell. Although not shown, an insulating material is positioned in an annular space 22 defined between the inner tank and the outer tank of the storage tank 16. In some implementations, the annular space between the inner tank and the outer tank is vacuum insulated. The LNG is then retained within the interior of the inner tank. The LNG vehicle tank pressure control system 12 can be used in mobile or non-mobile applications, but is typically onboard a vehicle.

In the depicted embodiment, the fuel delivery system 10 includes a fill nozzle 24, which acts as an interface to allow for the tank to be filled with LNG at a station. The fuel delivery system 10 further includes a check valve 26, which retains the pressure of the storage tank 16 after being filled with LNG. Additionally, the fuel delivery system 10 includes a vent valve 28, which may be a vent to a station hand valve. The colder LNG, as compared to CNG, is denser and allows for more natural gas to be put in the same size tank, which results in more stored energy per unit area of the storage tank 16.

As depicted, the fuel delivery system 10 further includes an engine delivery line 30 that delivers the natural gas from the storage tank 16 to the engine. The fuel delivery system 10 further includes a liquid valve 32 and a first heat exchanger 34. The liquid valve 32 is a liquid isolation valve that feeds the LNG from the storage tank 16 to the first heat exchanger 34. The engine delivery line 30 runs through the first heat exchanger 34, which is configured to heat and vaporize the LNG to CNG, such that CNG is delivered to the engine. In the depicted embodiment, coolant form a coolant system (with a coolant source) cycles through a second heat exchanger 36 of the pressure control system 12, via a second inlet of the second heat exchanger 36, as will be described in more detail below, and continues through the first heat exchanger 34 before cycling back through the engine. Accordingly, the existing coolant system of the engine can be used to vaporize LNG to CNG before delivery of the CNG to the engine for combustion. In some embodiments the second heat exchanger 36 and the first heat exchanger 34 are in series with each other. In some embodiments, the engine coolant cycles through the second heat exchanger 36 first before passing through the first heat exchanger 34. In certain embodiments, the engine coolant cycles through the first heat exchanger 34 first. The second heat exchanger 36 and the first heat exchanger 34 can be in parallel with each other and may receive engine coolant from the engine via separate lines.

Also depicted in the embodiment of the fuel delivery system 10 of FIG. 1 are a primary pressure relief valve 38, a secondary pressure relief valve 40, a tank pressure gauge 42, and an economizer 44. In one implementation, the primary pressure relief valve 38 is set to a predetermined pressure level (e.g., 230 psig) to relieve pressure in the fuel delivery system 10. According to one implementation, the secondary pressure relief valve 40 is set to a second predetermined pressure level (e.g., 250 psig) to relieve pressure in the fuel delivery system 10. The tank pressure gauge 42 includes a visual display of the tank pressure in some implementations. The economizer 44 is a regulator or other valve type that reduces tank pressure while feeding the engine, when above a specified set point.

In some embodiments, the fuel delivery system 10 is customized to broadcast additional parameters (e.g., storage tank level, storage tank pressure, warnings, valve states, diagnostics, and fuel temperature, etc.). In certain embodiments, controls of the fuel delivery system 10 are integrated into a human machine interface (HMI) through the original equipment manufacturer's controller area network (CAN) for the vehicle or otherwise to provide more information to the operator, mechanics, and/or service technicians. Some embodiments also have user adjustable set-points, manual on/off controls, etc.

Although the illustrated fuel delivery system 10, and associated pressure control system 12 of FIG. 1 is shown and described with certain components and functionality, other embodiments of the system may include fewer or more components to implement less or more functionality.

In the depicted embodiment, the pressure control system 12 includes a pressure builder isolation valve 46, which, in some implementations, is a manual shut off of the pressure control system 12 to allow for servicing the pressure control system 12. Through this pressure builder isolation valve 46, LNG from the storage tank 16 may be fed into the second heat exchanger 36 via a first inlet of the second heat exchanger. In some embodiments, the LNG is gravity fed from the storage tank 16 to the second heat exchanger 36. The LNG passes through the second heat exchanger 36, which heats the LNG (e.g., vaporizes the LNG into CNG) for the purpose of controlling (e.g., increasing) the pressure of the storage tank 16, and exits the second heat exchanger 36 via a first outlet. In the depicted embodiment, the second heat exchanger 36 receives coolant from the engine as noted above. Accordingly, the existing engine coolant system is utilized in heating the LNG, and vaporizing the LNG into CNG in some implementations, before communicating the CNG back to the storage tank 16. In some embodiments, a line 48 allows engine coolant to run from the engine through the second heat exchanger 36. Using the coolant from the engine coolant system to regulate the pressure of LNG in the storage tank 16 results in cost and weight savings, as well as a time savings associated with installation of the pressure control system 12.

The pressure control system 12 further includes a pressure build-up “PB” control valve 50, which may be a solenoid valve that is normally closed, but can be opened to activate the pressure control system 12 to increase the pressure in the storage tank 16 and subsequently closed to deactivate the pressure control system 12. In the depicted embodiment, the pressure control system 12 further includes a tank pressure sensor 52, which reads the pressure of the storage tank 16 and feeds the pressure reading to a controller to determine the pressure within the storage tank 16. Based on the pressure reading from the tank pressure sensor 52, the controller operates the PB control valve 50 to open and close as needed. In some embodiments, the pressure control system 12 will open the PB control valve 50 when pressure is below a predetermined lower pressure threshold (e.g., 120 psig). Once opened, the pressure control system 12 will cycle LNG from the storage tank 16 through the second heat exchanger 36, to vaporize the LNG, and back to the storage tank 16 until pressure within the storage tank 16 reaches a predetermined upper pressure threshold (e.g., 140 psig). As mentioned above, when the PB control valve 50 is open, LNG from the storage tank 16 will cycle through the second heat exchanger 36 and return to the storage tank 16. Depending on vehicle operational conditions, the predetermined upper and lower pressure thresholds can be dynamically adjusted, based on operating conditions of the vehicle (e.g., engine, duel delivery system, pressure control system, coolant system, etc.), by the controller of the pressure control system 12.

Based on the foregoing, in some embodiments, the pressure control system 12 allows for quickly and precisely controlling the pressure in the storage tank 16 by using a compact heat exchanger and existing engine systems, without the need for extraneous pumps, electrical heaters, or additional pressure vessels.

Because of the pressure control system 12, in some embodiments, the fuel delivery system 10 is not restricted to using LNG with saturation pressures higher than 120 psig. In other words, the pressure control system 12 facilities the use of “cold” LNG fuel (e.g., down to 30 psig) because the LNG will be heated and pressurized to maintain the pressure in the storage tank 16 suitable for proper engine operation.

The pressure control system 12 maintains the pressure in the storage tank 16 at the required delivery pressure requirements for all major spark-ignited and dual-fuel engines on the market today. Furthermore, the pressure control system 12 allows for colder, denser liquefied natural gas fuel to be stored at the station and dispensed into the vehicle tank, resulting in fewer losses due to venting by the station and the consumer. Generally, the pressure control system 12 allows for any condition (“warm” or “cold”) LNG fuel to be used by the engine. The tank pressure control provided by the pressure control system 12 is performed in response to the vehicle being “keyed” on. For easy integration on the vehicle, the existing CAN of the vehicle and engine operational conditions are used for controlling operation of the pressure control system 12. In some embodiments, all of the components are external to the storage tank (e.g., external to a shroud enclosure 14 of the storage tank 16), allowing for installation and maintenance of the pressure control system 12 to be easier, which may reduce the chance of malfunction. In some versions, the pressure control system 12 is integrated within a shroud enclosure 14 of the storage tank 16. As shown, the fuel delivery system 10 can be integrated within the shroud enclosure 14 of the storage tank 16.

In some embodiments, a control module (e.g., control module 160 or control module 260) uses an automated control system that reads the existing Society of Automotive Engineers (SAE) J1939 Serial Control and Communications Vehicle Network for engine and vehicle operational parameters, reads sensors contained within the pressure control system 12, applies a series of programmable logic gates, and then broadcasts control signals to components within the pressure control system 12. When needed, LNG is allowed to flow from the storage tank 16 through the second heat exchanger 36 where the LNG is heated and vaporized and then returned to the storage tank 16.

In the depicted embodiment, the pressure control system 12 further includes a separate and closed coolant loop 54 that facilitates pressure regulation, as described above, when the engine is “keyed” on (e.g., in a keyed-on state), but is not running (e.g., in a running state). The separate and closed coolant loop 54 of the pressure control system 12 includes a coolant pump 56, also defined herein as a secondary coolant pump, and a coolant bypass valve 58. When the engine is running, engine coolant cycles through the second heat exchanger 36 via a main coolant pump of the coolant system of the engine, exclusively, without the use of the coolant pump 56 (i.e., secondary coolant pump). However, when the engine is off, but “keyed” on, and the pressure within the storage tank 16 is below the predetermined lower pressure threshold, the coolant bypass valve 58 opens and the coolant pump 56 is operated to pump coolant into and through the second heat exchanger 36, exclusively, which results in the first heat exchanger 34 being bypassed. When the engine is running, the coolant bypass valve 58 is closed to prevent coolant from passing through the separate coolant loop and from bypassing the first heat exchanger 34. The coolant bypass valve 58 and coolant pump 56 are controlled by a controller or control module of the pressure control system 12. The upper pressure thresholds may be different depending on whether the engine is off or on. For example, in some embodiments, there are two pressure building conditions for increasing pressure within the storage tank 16: (1) engine off, keyed on, PB control valve 50 open, coolant pump 56 on, bypass valve 58 open, and first upper pressure threshold (e.g., 140 psig); and (2) engine on, PB control valve 50 open, coolant pump 56 off, bypass valve 58 closed, and second upper pressure threshold (e.g., 120 psig) different than first upper pressure threshold. In some implementations, a control module facilitates the automated functionality of the fuel delivery system 10 and the pressure control system 12. The control module also controls operation of an entire engine system, which includes the fuel delivery system 10 and the pressure control system 12, in some embodiments.

As described above, embodiments of the pressure control system 12 may be significantly more compact than existing systems and methods, such as those that require ambient-style heat exchangers or electrical heaters. Ambient-style heat exchangers require significant space, which may not be available for all vehicle tank mounting locations. Electrical heaters require electrical power consumption, which may cause battery drain for extended periods of time. Accordingly, the pressure control system 12 provides a cost, weight, space, and time savings (for installation) compared to prior art heating techniques. Utilizing an automated control system allows for fast dynamic control of pressure in the storage tank 16 and allows for code-based system adjustments should set-points need to be changed for varying fuel conditions or applications. Further, with the size and footprint of the pressure control system 12 significantly reduced, the entire system can be integrated into a small module mounted behind a storage tank 16 or designed into the pluming arrangement of the storage tank 16 itself.

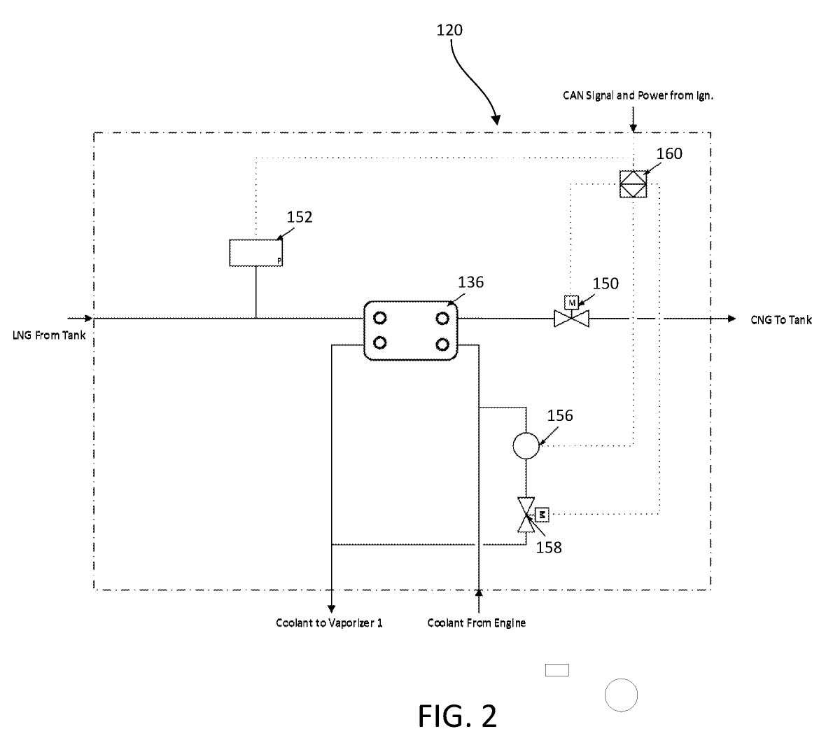

As shown in FIG. 2, according to one embodiment, a pressure control system 120, which is similar to the pressure control system 12 of FIG. 1, operates to pressurize a storage tank (not shown) that stores LNG. The storage tank can be similar to the storage tank 16 shown and described in association with FIG. 1. The pressure control system 120 can be used in mobile or non-mobile applications, but is onboard a vehicle in most embodiments. In the depicted embodiment of FIG. 2, the pressure control system 120 includes a tank pressure sensor 152, a heat exchanger 136, a control valve 150, and a control module 160. The illustrated embodiment further includes a coolant pump 156 and a control valve 158. Although the pressure control system 120 illustrated in FIG. 2 is shown and described with certain components and functionality, other embodiments of the system may include fewer or more components to implement less or more functionality.

In the depicted embodiment, the heat exchanger 136 receives LNG from a storage tank (not shown). In some embodiments, the heat exchanger 136 is a flat-plate heat exchanger. In certain embodiments, the heat exchanger 136 is another type of heat exchanger, such as, for example, a shell-and-tube heat exchanger. In the depicted embodiment, the heat exchanger 136 receives coolant from the engine which cycles through the heat exchanger 136 and returns to the engine. In the depicted embodiment, the coolant pump 156 and the control valve 158 are utilized when the engine is not running, but is keyed on. When the engine is not running, but keyed on, the control valve 158 is open and the coolant pump 156 is pumping coolant in a loop through the heat exchanger 136, which causes the coolant to bypass a primary heat exchanger (not shown) that heats LNG being delivered to the engine. This allows LNG from the storage tank to be heated and for coolant to cycle through the heat exchanger 136 even when the engine is not running. When the engine is running, the control valve 158 closes to prevent coolant from entering the coolant loop in the pressure control system 120 and from bypassing the primary heat exchanger. The use of a separate coolant pump 156 allows for the system and apparatus to maintain an adequate pressure in the storage tank, which helps to ensure adequate delivery pressure to the engine, even when the engine is not running.

In the depicted embodiment, the control module 160 is connected, or otherwise in communication with, the tank pressure sensor 152, the ignition system (not shown), the control valve 150, the coolant pump 156, and the coolant control valve 158. In some embodiments, the control module 160 is configured to open/close valves, activate pumps, and otherwise implement the steps and methods described herein. Based on a reading from the tank pressure sensor 152, the control module 160 may open control valve 150 to allow LNG to cycle from the storage tank, through the heat exchanger 136, and back to the storage tank. In this way, the storage tank pressure may be kept within an optimal level (e.g., between 120 psig and 140 psig). In addition, based on signals from the ignition system of a vehicle, the control module 160 may open and close the coolant control valve 158 and activate the coolant pump 156.

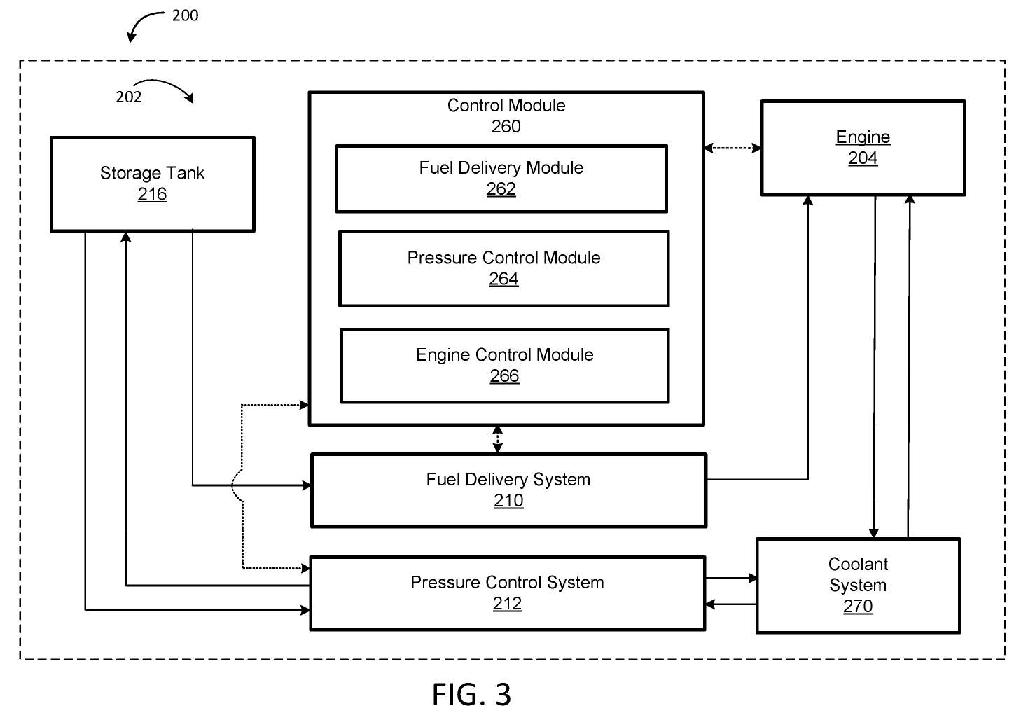

Referring to FIG. 3, one embodiment of a vehicle 200 with a system 202 is shown. The vehicle 200 can be any of various types of vehicles, such as a semi-truck, truck, car, boat, aircraft, etc., powered by an internal combustion engine 204. Alternatively, the vehicle 200 can be a non-mobile structure, such as a refueling station, without departing from the essence of the disclosure. The system 202 includes a storage tank 216 that stores LNG and is configured like the storage tank 16. The system 202 also includes a fuel delivery system 210 with features and functionality analogous to the features and functionality of the fuel delivery system 10. Furthermore, the system 202 includes a pressure control system 212 with features and functionality analogous to the features and functionality of the pressure control system 12. The system 202 additionally includes a coolant system 270 for the engine 204. Generally, the coolant system 270 supplies coolant to the engine 204 for cooling the engine.

The system 202 also includes a control module 260 configured to control the operation of the system 202. As represented by dashed lines, the control module 260 provides electronic communication signals to and receives electronic communication signals from the engine 204, the fuel delivery system 210, the pressure control system 212, and the coolant system 270 (as indicated by dashed arrows). Solid arrows indicate the flow of physical material, such as LNG and coolant. The control module 260 includes an engine control module 266 that controls operation of the engine 204. For example, based on user input, the engine control module 266 operates the engine 204 in a “keyed” on mode or running mode. Accordingly, in one implementation, the engine control module 266 tracks whether the engine 204 is operating in the “keyed” on mode or the running mode. Additionally, in some implementations, the engine control module 266 controls the operation of the coolant system 270 to supply coolant to the engine 204 based on operating parameters of the engine 204.

The control module 260 also includes a fuel delivery module 262 that controls operation of the fuel delivery system 210 to control parameters of LNG delivered to the engine 204 from the storage tank 216. For example, the fuel delivery module 262 operates the components of the fuel delivery system 210 to control the flow rate, pressure, and vaporization state of LNG delivered to the engine 204.

Additionally, the control module 260 includes a pressure control module 264 that controls operation of the pressure control system 212 to regulate the pressure of LNG in the storage tank 216. The pressure control system 212 receives some LNG from the storage tank 216, heats that portion of LNG with coolant from the coolant system 270, and returns the heated portion of LNG to the storage tank 216, which increases the pressure of LNG in the storage tank 216. Accordingly, the pressure control module 264 operates the components of the pressure control system 212 to increase the pressure of LNG in the storage tank 216 under certain operating conditions as presented above.

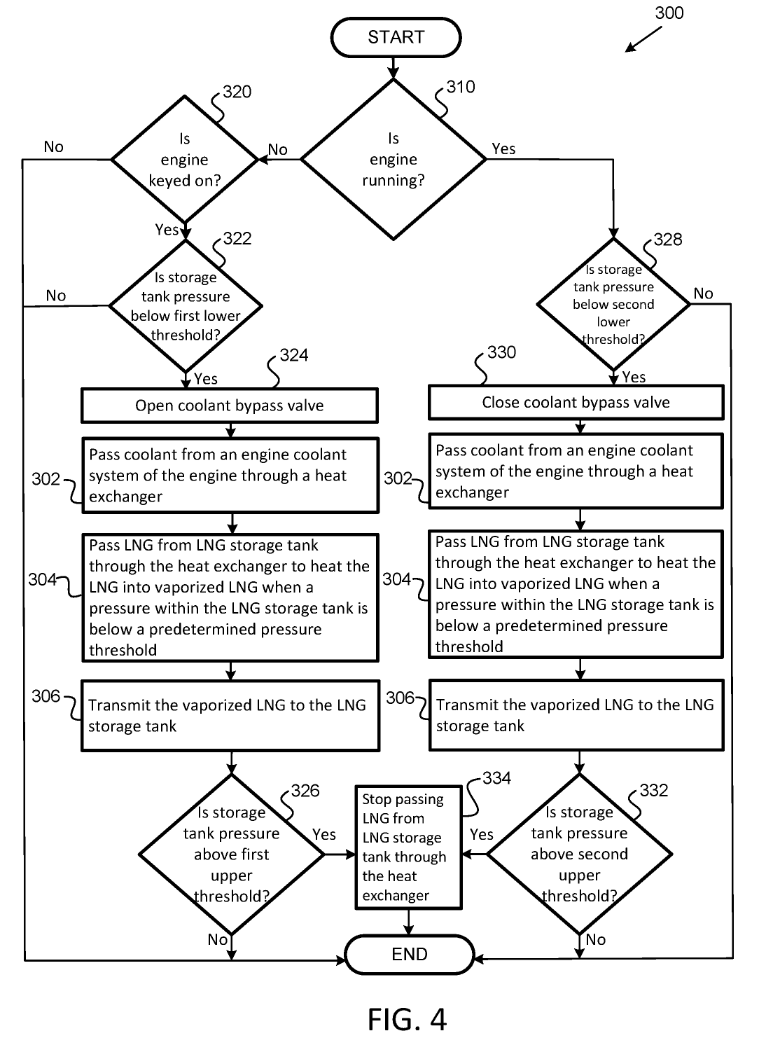

Now referring to FIG. 4, according to one embodiment, a method 300 of controlling pressure in an LNG storage tank. The steps of the method 300 can be executed by any one or more components of the various vehicles, systems, and modules described herein. The method 300 includes determining whether an engine, such as an engine of a vehicle, is running at 310. If the engine is not running at 310, then the method 300 determines whether the engine is “keyed” on at 320. If the engine is not “keyed” on, then the method 300 ends. However, if the engine is “keyed” on, then the method 300 proceeds to determine whether the pressure within an LNG storage tank is below a first lower threshold at 322. If the pressure within the LNG storage tank is at or above the first lower threshold at 322, then no increase in the LNG storage tank pressure is necessary and the method 300 ends. However, if the pressure within the LNG storage tank is below the first lower threshold at 322, then the method 300 initiates a first LNG storage tank pressure increase operation by opening a coolant bypass valve, such as the coolant bypass valve 58, or ensuring the coolant bypass valve is open at 324.

After opening the coolant bypass valve at 324, the method 300 continues with the first LNG storage tank pressure increase operation by passing coolant from an engine coolant system of the engine through a heat exchanger at 302 (e.g., a second heat exchanger via a secondary coolant pump), passing LNG from the LNG storage tank through the heat exchanger to heat the LNG into vaporized LNG at 304, and transmitting the vaporized LNG to the LNG storage tank at 306. Then, the method 300 includes determining whether the pressure within the LNG storage tank is above a first upper threshold, higher than the first lower threshold, at 326. If the pressure within the LNG storage tank is not above the first upper threshold at 326, the method 300 ends and restarts, or continues with the first LNG storage tank pressure increase operation. However, if the pressure within the LNG storage tank is above the first upper threshold at 326, then the method 300 stops passing LNG from the LNG storage tank through the heat exchanger at 334, to end the first LNG storage tank pressure increase operation, and the method 300 ends.

Returning back to step 310 of the method 300, if the engine is running, then the method 300 determines whether the pressure within the LNG storage tank is below a second lower threshold at 328. In one implementation, the second lower threshold is the same as the first lower threshold. In another implementation, the second lower threshold is different than (e.g., lower than) the first lower threshold. If the pressure within the LNG storage tank is at or above the second lower threshold at 322, then no increase in the LNG storage tank pressure is necessary and the method 300 ends. However, if the pressure within the LNG storage tank is below the second lower threshold at 328, then the method 300 initiates a second LNG storage tank pressure increase operation by closing a coolant bypass valve, such as the coolant bypass valve 58, or ensuring the coolant bypass valve is closed at 330.

After closing the coolant bypass valve at 330, the method 300 continues with the second LNG storage tank pressure increase operation by passing coolant from an engine coolant system of the engine through a heat exchanger at 302 (e.g., a primary heat exchanger via regular flow of coolant through engine), passing LNG from the LNG storage tank through the heat exchanger to heat the LNG into vaporized LNG at 304, and transmitting the vaporized LNG to the LNG storage tank at 306. Then, the method 300 includes determining whether the pressure within the LNG storage tank is above a second upper threshold, higher than the second lower threshold, at 332. In one implementation, the second upper threshold is the same as the first upper threshold. In another implementation, the second upper threshold is different than (e.g., lower than) the first upper threshold. If the pressure within the LNG storage tank is not above the second upper threshold at 332, the method 300 ends and restarts, or continues with the second LNG storage tank pressure increase operation. However, if the pressure within the LNG storage tank is above the second upper threshold at 332, then the method 300 stops passing LNG from the LNG storage tank through the heat exchanger at 334, to end the second LNG storage tank pressure increase operation, and the method 300 ends.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As will be appreciated by one skilled in the art, aspects of the embodiments may be embodied as a system, method or apparatus (e.g., program product). Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As mentioned above, aspects of the embodiments are described above with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

The description of elements in each figure may refer to elements of proceeding figures. Like numbers refer to like elements in all figures, including alternate embodiments of like elements.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A pressure control system for a liquid natural gas (LNG) storage tank, the pressure control system comprising:
a second heat exchanger, comprising a first inlet fluidly coupled with the LNG storage tank and a first outlet fluidly coupled with the LNG storage tank;
a coolant, fluidly coupled with a second inlet of the second heat exchanger, wherein the heat exchanger is configured to transfer energy from the coolant to the LNG from the LNG storage tank to vaporize the LNG into compressed natural gas (CNG); and
a first control valve selectively operable to allow LNG to flow from the LNG storage tank to the heat exchanger and to allow CNG to flow from the heat exchanger to the LNG storage tank when a pressure within the LNG storage tank is below a lower pressure threshold.

2. The pressure control system according to claim 1, wherein the first control valve is further selectively operable to prevent LNG from flowing from the LNG storage tank to the second heat exchanger and to prevent CNG from flowing from the heat exchanger to the LNG storage tank when pressure within the LNG storage tank is above an upper pressure threshold that is higher than the lower pressure threshold.

3. The pressure control system according to claim 2, wherein the upper pressure threshold and the lower pressure threshold are dynamically adjustable based on operating conditions of a vehicle comprising the pressure control system.

4. The pressure control system according to claim 1, further comprising a coolant pump selectively operable to pump the coolant into the second heat exchanger.

5. The pressure control system according to claim 4, further comprising a bypass valve selectively operable to allow coolant to be pumped into the second heat exchanger by the coolant pump, wherein the second heat exchanger and the coolant pump form a closed coolant loop when the bypass valve allows coolant to be pumped into the second heat exchanger by the coolant pump.

6. A vehicle, comprising:
an engine fueled by liquid natural gas (LNG);
a storage tank configured to store LNG;
a fuel delivery system configured to deliver LNG from the storage tank to the engine; and
a pressure control system, comprising:
a second heat exchanger, comprising a first inlet fluidly coupled with the LNG storage tank and a first outlet fluidly coupled with the LNG storage tank;
a coolant, fluidly coupled with a second inlet of the second heat exchanger, wherein the second heat exchanger is configured to transfer energy from the coolant to the LNG from the LNG storage tank to vaporize the LNG into compressed natural gas (CNG); and
a first control valve selectively operable to allow LNG to flow from the LNG storage tank to the second heat exchanger and to allow CNG to flow from the second heat exchanger to the LNG storage tank when a pressure within the LNG storage tank is below a lower pressure threshold.

7. The vehicle according to claim 6, wherein the first control valve is further selectively operable to prevent LNG from flowing from the LNG storage tank to the second heat exchanger and to prevent CNG from flowing from the second heat exchanger to the LNG storage tank when pressure within the LNG storage tank is above an upper pressure threshold that is higher than the lower pressure threshold.

8. The vehicle according to claim 7, wherein:
the engine is operable in a keyed-on state and a running state;
when the engine is operating in the keyed-on state, the upper pressure threshold is a first upper pressure threshold;
when the engine is operating in the running state, the upper pressure threshold is a second upper pressure threshold; and
the first upper pressure threshold is different than the second upper pressure threshold.

9. The vehicle according to claim 8, wherein the first upper pressure threshold is higher than the second upper pressure threshold.

10. The vehicle according to claim 9, wherein the first upper pressure threshold is about 140 psig and the second upper pressure threshold is about 120 psig.

11. The vehicle according to claim 9, wherein the fuel delivery system comprises a first heat exchanger, separate from the second heat exchanger, fluidly coupled with the coolant and configured to transfer energy from the coolant to the LNG being delivered to the engine to vaporize the LNG into CNG before delivery to the engine.

12. The vehicle according to claim 11, further comprising a coolant system configured to deliver coolant to the first heat exchanger and the engine, wherein the coolant system comprises a main coolant pump operable to pump coolant through the first heat exchanger and the engine.

13. The vehicle according to claim 12, wherein the pressure control system further comprises a secondary coolant pump, separate from the main coolant pump, operable to pump coolant into the second heat exchanger.

14. The vehicle according to claim 13, wherein:
the engine is operable in a keyed-on state and a running state;
in the keyed-on state, coolant is pumped into the second heat exchanger exclusively by the secondary coolant pump; and
in the running state, coolant is pumped into the second heat exchanger exclusively by the main coolant pump.

15. The vehicle according to claim 14, wherein:
the pressure control system further comprises a bypass valve that is closed in the running state and open in the keyed-on state;
when open, coolant bypasses the first heat exchanger to prevent coolant from being delivered to the first heat exchanger and coolant is allowed to be pumped into the second heat exchanger by the secondary coolant pump; and
when closed, coolant bypasses the secondary coolant pump and coolant is allowed to be pumped into the second heat exchanger and the first heat exchanger by the main coolant pump.

16. The vehicle according to claim 15, wherein the second heat exchanger and the secondary coolant pump form a closed coolant loop when the bypass valve is open.

17. The vehicle according to claim 6, further comprising a shroud enclosure, wherein:
the storage tank is enclosed within the shroud enclosure;
the pressure control system is external to the shroud enclosure; and
the fuel delivery system is enclosed within the shroud enclosure.

18. A method of controlling pressure in a liquid natural gas (LNG) storage tank, configured to supply natural gas to an engine, the method comprising:
passing coolant from an engine coolant system of the engine through a second heat exchanger;
passing LNG from the LNG storage tank through the second heat exchanger to heat the LNG into first vaporized LNG when a pressure within the LNG storage tank is below a lower pressure threshold; and
transmitting the first vaporized LNG to the LNG storage tank.

19. The method according to claim 18, further comprising, when the engine is running and a pressure within the LNG storage tank is below a first upper pressure threshold:
closing a coolant bypass valve;
passing coolant from the engine coolant system of the engine through a first heat exchanger, separate from the second heat exchanger;
passing LNG from the LNG storage tank through the first heat exchanger to heat the LNG into second vaporized LNG; and
transmitting the second vaporized LNG to the engine.

20. The method according to claim 19, further comprising, when the engine is keyed-on and the pressure within the LNG storage tank is below a second upper pressure threshold, different than the first upper pressure threshold:
opening a coolant bypass valve; and
passing coolant from the engine coolant system through a closed coolant loop comprising the coolant bypass valve and the second heat exchanger, wherein the closed coolant loop does not include the first heat exchanger.
